(19) United States
(12) Patent Application Publication
(10) Pub. No.: US 2025/0279101 A1
(43) Pub. Date: Sep. 4, 2025

(54) AUDIO ENCODING METHOD, AUDIO DECODING METHOD, AUDIO ENCODING APPARATUS, AUDIO DECODING APPARATUS, DEVICE, AND STORAGE MEDIUM

(71) Applicant: Douyin Vision Co., Ltd., Beijing (CN)

(72) Inventors: Jiawei JIANG, Beijing (CN); He WANG, Beijing (CN); Dejun ZHANG, Beijing (CN); Jian XU, Beijing (CN); Ziqian WU, Beijing (CN); Kunpeng LIN, Beijing (CN)

(21) Appl. No.: 19/211,007

(22) Filed: May 16, 2025

Related U.S. Application Data
(63) Continuation of application No. PCT/CN2023/132288, filed on Nov. 17, 2023.

(30) Foreign Application Priority Data
Nov. 17, 2022 (CN) 202211459916.4

(51) Int. Cl. G10L 19/002; G10L 19/02; G10L 19/032

(52) U.S. Cl. CPC G10L 19/002; G10L 19/0204; G10L 19/032

(57) ABSTRACT

This disclosure discloses an audio encoding method, an audio decoding method, an audio encoding apparatus, an audio decoding apparatus, an electronic device and a storage medium. The audio encoding method includes: encoding coarse energy of a plurality of sub-bands of a high frequency band corresponding to an audio frame to obtain a first bitstream; and encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

### CROSS-REFERENCE TO RELATED APPLICATIONS

The present disclosure is a continuation application, under 35 U.S.C. § 111 (a), of International Patent Application No. PCT/CN2023/132288, filed on Nov. 17, 2023, which is based on and claims priority of Chinese Application No. 202211459916.4, filed on Nov. 17, 2022, the disclosures of which are hereby incorporated into this disclosure by reference in their entireties.

### TECHNICAL FIELD

The embodiments of the present disclosure relate to the technical field of audio encoding and decoding, in particular to an audio encoding method, decoding method, apparatus, device, and a storage medium.

### BACKGROUND

There is often packet loss in the transmission of audio data, and Forward error correction (FEC) technology is usually adopted to overcome packet loss. When using FEC technology to encode, not only the information of the frame (i.e., the main frame) will be encoded, but also the information of the historical frame (i.e., the redundant frame) will be encoded.

### SUMMARY

In a first aspect, an embodiment of the present disclosure provides an audio encoding method, including:
encoding coarse energy of a plurality of sub-bands of a high frequency band corresponding to an audio frame to obtain a first bitstream; and
encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

In a second aspect, an embodiment of the present disclosure also provides an audio decoding method, including:
decoding a first bitstream in an audio bitstream to determine coarse energy of a plurality of sub-bands in a high frequency band;
decoding, based on sub-remaining decoding bit(s) obtained by allocating remaining decoding bit(s) to the plurality of sub-bands, a second bitstream in the audio bitstream to obtain fine energy, wherein the remaining decoding bit(s) are determined according to used decoding bits and set decoding bits, and the used decoding bits are determined according to decoding bit(s) for decoding the first bitstream; and
determining an audio frame based on the coarse energy and the fine energy.

In a third aspect, an embodiment of the present disclosure also provides an audio encoding apparatus, including:
a first encoding module configured for encoding coarse energy of a plurality of sub-bands of a high frequency band corresponding to an audio frame to obtain a first bitstream; and
a second encoding module configured for encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

In a fourth aspect, an embodiment of the present disclosure also provides an audio decoding apparatus, including:
a coarse energy determination module configured for decoding a first bitstream in an audio bitstream to determine coarse energy of a plurality of sub-bands in a high frequency band;
a fine energy acquisition module configured for decoding, based on sub-remaining decoding bit(s) obtained by allocating remaining decoding bit(s) to the plurality of sub-bands, a second bitstream in the audio bitstream to obtain fine energy, wherein the remaining decoding bit(s) are determined according to used decoding bits and set decoding bits, and the used decoding bits are determined according to decoding bit(s) for decoding the first bitstream; and
an audio frame determination module for determining an audio frame based on the coarse energy and the fine energy

In a fifth aspect, an embodiment of the present disclosure also provides an electronic device, comprising:
at least one memory; and
   at least one processor coupled to the memory, the processor being configured to, based on instructions stored in the memory, perform the audio encoding method or the audio decoding method according to the embodiment of the present disclosure.

In a sixth aspect, an embodiment of the present disclosure also provides a non-transitory storage medium including computer-executable instructions, which, when executed by a computer processor, are used for performing the audio encoding method or the audio decoding method according to the embodiments of the present disclosure.

In a seventh aspect, an embodiment of the present disclosure also provides a computer program, including instructions that, when executed by a processor, cause the processor to perform the audio encoding method or the audio decoding method according to the embodiments of the present disclosure.

### BRIEF DESCRIPTION OF THE DRAWINGS

The above and other features, advantages, and aspects of embodiments of the present disclosure will become more apparent by referring to the following detailed description when taken in combination with the accompanying drawings. Throughout the drawings, the same or similar reference signs refer to the same or similar elements. It should be understood that the drawings are schematic and that the originals and elements are not necessarily drawn to scale.

FIG. 1 is a flow schematic diagram of an audio encoding method provided by an embodiment of the present disclosure;

FIG. 2a is an example diagram of a high frequency band provided by an embodiment of the present disclosure;

FIG. 2b is an example diagram of dividing residual energy into a first self-residual energy and a second self-residual energy provided by an embodiment of the present disclosure;

FIG. 3 is a flow schematic diagram of an audio decoding method provided by an embodiment of the present disclosure;

FIG. 4 is a structural schematic diagram of an audio encoding apparatus provided by an embodiment of the present disclosure;

FIG. 5 is a structural schematic diagram of an audio decoding apparatus provided by an embodiment of the present disclosure;

FIG. 6 is a structural schematic diagram of an electronic device provided by an embodiment of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be embodied in various forms and should not be construed as limited to the embodiments set forth herein, but rather these embodiments are provided for a more complete and thorough understanding of the present disclosure. It should be understood that the drawings and embodiments of the present disclosure are for illustration purposes only and are not intended to limit the scope of the disclosure.

It should be understood that the various steps recited in the method embodiments of the present disclosure may be performed in a different order, and/or performed in parallel. Moreover, the method embodiments may include additional steps and/or omit performing the illustrated steps. The scope of the present disclosure is not limited in this respect.

The term “include” and variations thereof as used herein are intended to be open-ended, i.e., “include but not limited to”. The term “based on” is “based at least in part on”. The term “an embodiment” means “at least one embodiment”; the term “another embodiment” means “at least one other embodiment”; the term “some embodiments” means “at least some embodiments”. Relevant definitions for other terms will be given in the following description.

It should be noted that the concepts of “first”, “second”, and the like in the present disclosure are only used for distinguishing different devices, modules or units, and are not used for limiting the order of functions performed by the devices, modules or units or interdependence thereof.

It is noted that references to “a” or “a plurality of” mentioned in the present disclosure are intended to be illustrative rather than limiting, and those skilled in the art will appreciate that unless otherwise clearly indicated in the context, they should be understood as “one or more”.

The names of messages or information exchanged between devices in the embodiments of the present disclosure are for illustrative purposes only, and are not intended to limit the scope of the messages or information.

It may be understood that, prior to the use of the technical solutions disclosed in the embodiments of the present disclosure, users shall be informed of the type, the range of use, the scenarios of use, etc. of personal information involved in the present disclosure in a proper manner in accordance with relevant laws and regulations, and authorization of the users shall be obtained.

For example, when responding to receiving the user's active request, prompt information is sent to the user to clearly remind the user that the operation requested by the user will require the acquisition and use of the user's personal information. Therefore, the user can independently choose whether to provide personal information to software or hardware such as electronic devices, application programs, servers or storage media that perform the operations of the technical solution of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only illustrative, and does not limit the implementation of the present disclosure. Other ways to meet relevant laws and regulations can also be applied to the implementation of the present disclosure.

It can be understood that the data (including but not limited to the data itself, data acquisition or use) involved in this technical solution shall comply with the requirements of corresponding laws, regulations and relevant provisions.

In the related technology, only the low frequency part is encoded using the FEC technology, and the high frequency part is not encoded using the FEC technology, resulting in noise in the audio in the high frequency part and leading to a poor listening experience. Embodiments of the present disclosure provide an audio encoding method, decoding method, apparatus, and device and a storage medium, which encode high frequency band residual energy in the high frequency band and can reduce the noise of the encoded audio in the whole frequency band and improve the audio encoding quality, thereby improving the listening experience of audio data in the whole frequency band.

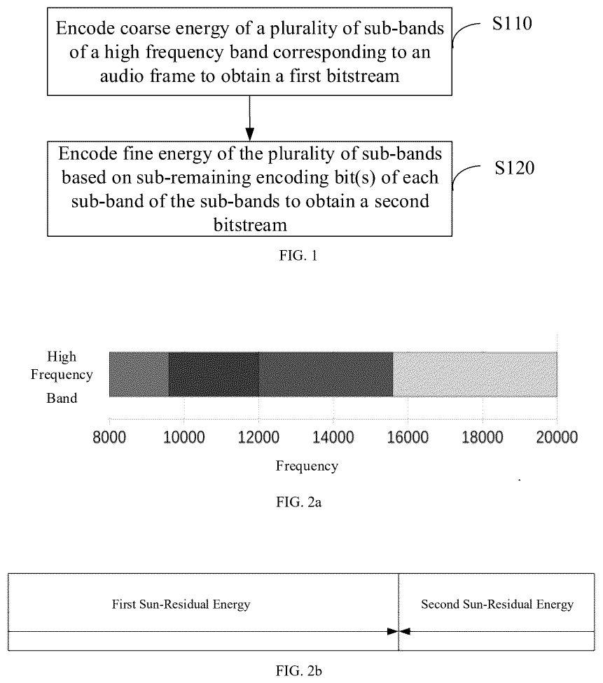

FIG. 1 is a flow schematic diagram of an audio encoding method provided by an embodiment of the present disclosure. The embodiment of the present disclosure is suitable for the case of encoding audio data. The method can be implemented by an audio encoding apparatus, which can be implemented in the form of software and/or hardware. Optionally, it can be implemented by an electronic device, which can be a mobile terminal, a PC terminal or a server.

As shown in FIG. 1, the encoding method includes steps S110 to S120.

S110: encoding coarse energy of a plurality of sub-bands of a high frequency band corresponding to an audio frame to obtain a first bitstream.

In some embodiments, the residual energy of each sub-band of the sub-bands is divided into the coarse energy and the fine energy based on a set energy resolution, and the residual energy of the each sub-band is a difference between actual energy and the predicted energy of the sub-band. The coarse energy can also be called first sub-residual energy, and the fine energy can also be called second sub-residual energy. The residual energy of the sub-band is the difference between the actual energy and the predicted energy of the sub-band. The coarse energy is a part of the residual energy that is capable of being evenly divided by the set energy resolution, and the fine energy is a remainder part of the residual energy after being evenly divided by the set energy resolution.

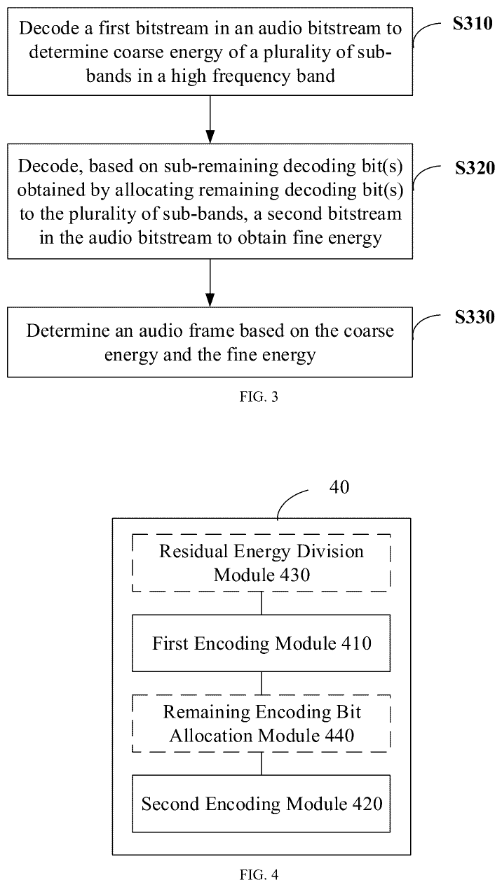

The high frequency band is a frequency band within a set frequency range and includes a plurality of sub-bands. Illustratively, FIG. 2a is an example diagram of a high frequency band in this embodiment, and as shown in FIG. 2a, the high frequency band is a frequency band of 8-20 kHz. In this embodiment, the audio within 8-20 kHz can be encoded, and the audio within 8-12 kHz can also be encoded.

The set energy resolution can be set in advance, for example, it can be 6 dB, 3 dB or 9 dB, which is not limited here.

In this embodiment, a method of dividing the residual energy of the each sub-band of the high frequency band corresponding to the audio frame into the coarse energy and the fine energy based on the set energy resolution can be as follows: for the each sub-band, converting the actual energy of the sub-band to a logarithmic domain to obtain actual logarithmic energy of the sub-band; determining a difference between the actual logarithmic energy and predicted logarithmic energy of the sub-band to obtain logarithmic residual energy of the sub-band; and dividing, based on the set energy resolution, the logarithmic residual energy of the sub-band into the coarse energy and the fine energy.

In some embodiments, the process of obtaining the actual energy of the each sub-band can be as follows: performing the following processing successively on the audio signal: pre-emphasis processing, pre-filtering processing, signal detection of transient-state and steady-state, windowing processing, Modified Discrete Cosine Transform (MDCT) processing and frequency band energy calculation. The process of each of the above processing stages can refer to existing audio signal processing methods, which is not limited here. And the above-mentioned audio signal processing process will consume a certain amount of encoding bit(s).

If the high frequency band is a frequency band of 8-12 kHz, it includes two sub-bands of 8-9.6 kHz and 9.6-12 kHz; if the high frequency band is a frequency band of 8-20 kHz, then it includes four sub-bands of 8-9.6 kHz, 9.6-12 kHz, 12-15.6 kHz and 15.6-20 kHz. The logarithmic residual energy of the each sub-band can be obtained by the difference between the actual logarithmic energy and the predicted logarithmic energy of the each sub-band of the audio frame. The predicted logarithmic energy of the each sub-band can be obtained by linear superposition of the actual logarithmic energy of this sub-band in the previous audio frame and the actual logarithmic energy of a previous sub-band.

In this embodiment, a method of converting the actual energy of the sub-band to the logarithmic domain may be as follows: performing a base-10 logarithmic conversion on the actual energy of the sub-band. Illustratively, assuming that the actual energy of the sub-band is m, the actual logarithmic energy of the sub-band can be expressed as log 10(m). The predicted logarithmic energy can be determined by the actual logarithmic energy of a previous audio frame in this sub-band and the actual logarithmic energy of the previous sub-band in the audio frame. Illustratively, assuming that the actual logarithmic energy of the previous audio frame in this sub-band is Q1 and the actual logarithmic energy of the previous sub-band in the audio frame is Q2, the predicted logarithmic energy can be expressed as: c*Q1+Q2, where c is an inter-frame prediction coefficient, which can be set in advance. Assuming that the actual logarithmic energy of this sub-band in the audio frame is Q0, the logarithmic residual energy can be expressed as Q0−(c*Q1+Q2).

In this embodiment, the process of dividing the logarithmic residual energy into the coarse energy and the fine energy based on the set energy resolution can be as follows: first, quotient the logarithmic residual energy with the set energy resolution, and then perform a rounding operation on the quotient result to the nearest integer to obtain quantization information corresponding to the coarse energy; then subtract a product of the quantization information corresponding to the coarse energy and the set energy resolution from the logarithmic residual energy to obtain the fine energy. Among them, the process of performing the rounding operation on the quotient result can be as follows: accumulate the quotient result with 0.5 to obtain an accumulation result, and finally take the integer part of the accumulation result. Assuming that F is the logarithmic residual energy and Q is the set energy resolution, the calculation process of the quantization information corresponding to the coarse energy can be: q1=rounding (F/Q+0.5), and the calculation process of the fine energy can be: F2=F−F1*Q. Illustratively, FIG. 2b is an example diagram of dividing the residual energy into a first self-residual energy and a second self-residual energy in this embodiment. As shown in FIG. 2b, the residual energy is divided into the first self-residual energy and the second self-residual energy.

Encoding the coarse energy can be understood as: performing main frame encoding on the coarse energy or performing redundant frame encoding on the coarse energy. In this embodiment, a certain amount of encoding bit(s) will be consumed when performing the main frame encoding or the redundant frame encoding on the coarse energy. The sum of the encoding bit(s) consumed for coarse energy encoding and the encoding bit(s) consumed for audio signal processing can be understood as used encoding bits, that is, the used encoding bits=the encoding bit(s) consumed for audio signal processing+the encoding bit(s) consumed for the coarse energy encoding. In this embodiment, the method to encode the coarse energy may be to encode with an existing encoder, which is not limited here.

In this embodiment, the coarse energy of a plurality of sub-bands is encoded respectively to obtain the used coding bits corresponding to the plurality of sub-bands respectively, and finally the used encoding bits corresponding to the plurality of sub-bands are accumulated. The sum of the accumulation result and the encoding bit(s) consumed by preprocessing is taken as the used encoding bits corresponding to the audio frame. The preprocessing includes, for example, encoding of silent frames, pre-filtering, encoding of transient frames, and encoding of predicted energy.

S120: encoding fine energy of the plurality of sub-bands based on sub-remaining encoding bit(s) of each sub-band of the sub-bands to obtain a second bitstream. The first bitstream and the second bitstream are used to form an encoded bitstream of the audio frame.

In some embodiment, the remaining encoding bits are determined according to the set encoding bits and the encoding bits for encoding the coarse energy of the plurality of the sub-bands. Then, the sub-remaining encoding bit(s) of the each sub-band are determined by allocating the remaining encoding bits to the each sub-band.

In some embodiments, the remaining encoding bits are a result of subtracting encoding bit(s) for preprocessing the audio frame and encoding bits for encoding the coarse energy of the plurality of sub-bands from the set encoding bits. As mentioned above, the preprocessing includes, for example, encoding of silent frame(s), pre-filtering, encoding of transient frame(s), and encoding of predicted energy.

The set encoding bits can be understood as the preset encoding bits corresponding to the audio frame, that is, the encoding bit(s) consumed after encoding the audio frame, which can be preset. In this embodiment, the calculation formula of the remaining encoding bits can be expressed as: remaining encoding bits=set encoding bits-used encoding bits, and the used encoding bits include encoding bit(s) consumed by the preprocessing and encoding bits consumed in the process of encoding the coarse energy.

In some embodiments, the remaining encoding bits can be allocated to a plurality of sub-bands according to a certain allocation ratio.

Specifically, the method to allocate the remaining encoding bits to the plurality of sub-bands may be as follows: allocating the remaining encoding bits to the plurality of sub-bands according to an allocation ratio of the plurality of sub-bands, wherein bit(s) allocated to the each sub-band are integer multiple of bit(s). Moreover, the unallocated encoding bit(s) are insufficient for all the sub-bands in the plurality of sub-bands to be allocated again according to the integer multiple of bit(s) and the allocation ratio.

The allocation ratio can be a preset allocation ratio. In this embodiment, assuming that the high frequency band is a frequency band of 8-20 kHz, it includes four sub-bands of Bit[0]: 8-9.6 kHz, Bit[1]: 9.6-12 kHz, Bit[2]: 12-15.6 kHz and Bit[3]: 15.6-20 kHz, the allocation ratio of which can be m:n:p:q. Illustratively, the allocation ratio of the four sub-bands can be set as Bit[0]:Bit[1]:Bit[2]:Bit[3]=2:1:1:1. Assuming that the high frequency band is a frequency band of 8-12 kHz, it includes two sub-bands of Bit[0]: 8-9.6 kHz and Bit[1]: 9.6-12 kHz, the allocation ratio of which can be m:n. Illustratively, the allocation ratio of the two sub-bands can be set as Bit[0]:Bit[1]=2:1.

Optionally, after allocating the remaining encoding bits to the plurality of sub-bands according to the allocation ratio, the method further includes: allocating, in response to remaining unallocated encoding bit(s), the unallocated encoding bit(s) to a part of the plurality of sub-bands based on the allocation ratio in an order from low frequency band to high frequency band, wherein bit(s) allocated to each sub-band are integer multiple of bit(s). That is, if there are unallocated encoding bit(s) that remain, then according to the allocation ratio, the unallocated encoding bit(s) are allocated to the low frequency band in the plurality of sub-bands in integer multiple of bit(s).

Specifically, assuming that the allocation ratio of the four sub-bands can be set as Bit[0]:Bit[1]:Bit[2]:Bit[3]=m:n:p:q, the part of the remaining encoding bits that can be divided evenly by (m+n+p+q) are allocated according to m:n:p:q, and then the remaining unallocated encoding bit(s) are preferentially allocated to the low frequency band among the four sub-bands according to m:n:p:q. Illustratively, assuming that the number of the remaining encoding bits is 8 and the allocation ratio of the four sub-bands is Bit[0]:Bit[1]:Bit[2]:Bit[3]=2:1:1:1, then five encoding bit(s) are allocated according to 2:1:1:1 firstly, and the number of remaining unallocated encoding bit(s) is 3, then two encoding bit(s) are allocated to the first sub-band Bit[0], and one encoding bit is allocated to the second sub-band Bit[1]. The final allocation result is: Bit[0]=4, Bit[1]=2, Bit[2]=1, Bit[3]=1. Assuming that the number of remaining encoding bits is 2, they are all allocated to the first sub-band Bit[0], and the final allocation result is: Bit[0]=2, Bit[1]=0, Bit[2]=0, Bit[3]=0.

Specifically, assuming that the allocation ratio of two sub-bands can be set as Bit[0]:Bit[1]=m:n, the part of the remaining encoding bits that can be evenly divided by (m+n) is allocated according to min, and then the remaining unallocated encoding bit(s) are preferentially allocated to the lower band of the two sub-bands according to m:n. Illustratively, assuming that the number of the remaining encoding bits is 8 and the allocation ratio of the four sub-bands is Bit[0]:Bit[1]=2:1, then six encoding bit(s) are allocated according to 2:1 firstly, and the number of the remaining unallocated encoding bit(s) is 2, then the two encoding bit(s) are allocated to the first sub-band Bit[0], and the final allocation result is: Bit[0]=6, Bit[1]=2. Assuming that the number of the remaining encoding bits is 2, they are all allocated to the first sub-band Bit[0], and the final allocation result is: Bit[0]=2, Bit[1]=0.

Specifically, the method to encode the fine energy of the each sub-band based on the sub-remaining encoding bit(s) can be as follows: quantizing the sub-remaining encoding bit(s) of the each sub-band according to the sub-remaining bit(s) and the set energy resolution to obtain quantization information of the sub-remaining encoding bit(s); and writing the quantization information into the encoded bitstream of the audio frame.

The quantization information may be a binary code. Specifically, the method to quantize the sub-remaining encoding bit(s) according to the sub-remaining bit(s) and the set energy resolution can be as follows: multiplying 0.5 with the set energy resolution to obtain a multiplication result, and then adding the fine energy to the multiplication result to obtain a summation result; then calculating the sub-remaining bit power of 2 to obtain an exponential operation result; then quotienting a product of the summation result and the exponential operation result with the set energy resolution to obtain the quantization information. Illustratively, assuming that the fine energy is F2, the set energy resolution is Q, and the sub-remaining bit is B, the quantization information can be expressed as q2=rounding ((F2+0.5*Q)*2\hat{ }b/Q). After obtaining the quantization information of the each sub-band, the quantization information is written into the audio bitstream to obtain a complete audio bitstream.

According to the audio encoding method provided by the embodiment of the present disclosure, after the coarse energy is encoded, the remaining encoding bits are allocated to the plurality of sub-bands, and the fine energy is encoded based on the allocated sub-remaining encoding bits. This can reduce the noise of the encoded audio in the whole frequency band, and improve the audio encoding quality, and thus enhance the listening experience of audio data in the whole frequency band.

FIG. 3 is a schematic diagram of an audio decoding method provided by an embodiment of the present disclosure. As shown in FIG. 3, the decoding method includes steps S310 to S330.

S310: decoding a first bitstream in an audio bitstream to determine coarse energy of a plurality of sub-bands in a high frequency band. The audio bitstream is an encoded bitstream of an audio frame to be determined.

The high frequency band is a frequency band within a set frequency range and includes a plurality of sub-bands. In this embodiment, the set frequency range may be 8-12 kHz or 8-12 kHz. If the high frequency band is a frequency band of 8-12 kHz, it includes two sub-bands of 8-9.6 kHz and 9.6-12 kHz; if the high frequency band is a frequency band of 8-20 kHz, it includes four sub-bands of 8-9.6 kHz, 9.6-12 kHz, 12-15.6 kHz and 15.6-20 kHz.

The method to determine the coarse energy of the audio frame can be as follows: decoding the audio frame with a decoder corresponding to the encoder in the above embodiments to obtain quantization information corresponding to the coarse energy, and multiplying the quantization information with a set energy resolution to obtain the coarse energy. Illustratively, the calculation process of the coarse energy is: F1=q1*Q, where q1 is the quantization information corresponding to the coarse energy and Q is the set energy resolution.

Based on the coarse energy, the used decoding bits can be determined.

The decoding bit(s) are bit(s) used when decoding the audio frame. On the decoding side, such bit(s) are described as decoding bit(s) for convenience of understanding. The used decoding bits can be understood as the sum of the decoding bit(s) corresponding to the coarse energy and the decoding bit(s) consumed in the audio decoding process. For example, the used decoding bits include the sum of the decoding bit(s) used for preprocessing the audio bitstream and the decoding bit(s) used for decoding the first bitstream. The preprocessing comprises, for example, decoding of silent frame(s), pre-filtering, decoding of transient frame(s), and decoding of predicted energy.

In some embodiments, the remaining decoding bit(s) are obtained according to the used decoding bits and the set decoding bits.

The set decoding bits can be understood as preset decoding bits corresponding to the audio frame. The method to determine the remaining decoding bit(s) according to the used decoding bits and the set decoding bits can be as follows: subtracting the used decoding bits from the set decoding bits to obtain the remaining decoding bit(s).

Then, the sub-remaining decoding bit(s) allocated by the remaining decoding bit(s) in each sub-band can be determined.

In this embodiment, the sub-remaining decoding bit(s) allocated to the each sub-band by the remaining decoding bit(s) are determined according to a preset allocation ratio.

The process of determining the sub-remaining decoding bit(s) allocated by the remaining decoding bit(s) in the each sub-band can be as follows: obtaining an allocation ratio of the remaining decoding bit(s) in the each sub-band; determining the sub-remaining decoding bit(s) allocated by the remaining decoding bit(s) in each sub-band according to the allocation ratio. Bit(s) allocated to each sub-band are integer multiple of bit(s).

The allocation ratio can be the same as that during the encoding. In this embodiment, assuming that the high frequency band is a frequency band of 8-20 kHz, it includes four sub-bands of Bit[0]: 8-9.6 kHz, Bit[1]: 9.6-12 kHz, Bit[2]: 12-15.6 kHz and Bit[3]: 15.6-20 kHz, and the allocation ratio of the four sub-bands can be m:n:p:q. Assuming that the high frequency band is a frequency band of 8-12 kHz, it includes two sub-bands of Bit[0]: 8-9.6 kHz and Bit[1]: 9.6-12 kHz, and the allocation ratio of the two sub-bands can be min. Illustratively, the allocation ratio of the two sub-bands can be set as Bit[0]:Bit[1]=2:1.

In some embodiments, in the case that there are unallocated decoding bit(s) that remain, the unallocated decoding bit(s) are allocated to a part of the plurality of sub-bands in an order from low frequency band to high frequency band based on the allocation ratio, and the bit(s) allocated to the each sub-band are integer multiple of bit(s). That is, if there are unallocated decoding bit(s) that remain, the unallocated decoding bit(s) are preferentially allocated to the low frequency band among the plurality of sub-bands according to the allocation ratio.

Specifically, assuming that the allocation ratio of the four sub-bands can be set as Bit[0]:Bit[1]:Bit[2]:Bit[3]=m:n:p:q, the part of the remaining decoding bit(s) that can be evenly divided by (m+n+p+q) are allocated according to m:n:p:q, and then the remaining unallocated decoding bit(s) are preferentially allocated to the low frequency band among the four sub-bands according to m:n:p:q. Illustratively, assuming that the number of the remaining decoding bit(s) is 8 and the allocation ratio of the four sub-bands is Bit[0]:Bit[1]:Bit[2]:Bit[3]=2:1:1:1, then five decoding bit(s) are allocated according to 2:1:1:1 firstly, and the number of remaining unallocated decoding bit(s) is 3, then two decoding bit(s) are allocated to the first sub-band Bit[0], and one decoding bit is allocated to the second sub-band Bit[1]. The final allocation result is: Bit[0]=4, Bit[1]=2, Bit[2]=1, Bit[3]=1. Assuming that the number of remaining decoding bit(s) is 2, they are all allocated to the first sub-band Bit[0], and the final allocation result is: Bit[0]=2, Bit[1]=0, Bit[2]=0, Bit[3]=0.

Specifically, assuming that the allocation ratio of the two sub-bands can be set as Bit[0]:Bit[1]=m:n, the part of the remaining decoding bits that can be evenly divided by (m+n) is allocated according to m:n, and then the remaining unallocated decoding bit(s) are preferentially allocated to the low band of the two sub-bands according to m:n. Illustratively, assuming that number of the remaining decoding bits is 8 and the allocation ratio of the four sub-bands is Bit[0]:Bit[1]=2:1, six decoding bit(s) are allocated according to 2:1 firstly, and the number of the remaining unallocated decoding bit(s) is 2, then the two decoding bit(s) are allocated to the first sub-band Bit[0], and the final allocation result is: Bit[0]=6, Bit[1]=2. Assuming that the number of the remaining decoding bit(s) are 2, they are all allocated to the first sub-band Bit[0], and the final allocation result is: Bit[0]=2, Bit[1]=0.

S320: decoding, based on sub-remaining decoding bit(s) obtained by allocating remaining decoding bit(s) to the plurality of sub-bands, a second bitstream in the audio bitstream to obtain fine energy.

In this embodiment, the process of decoding the audio bitstream according to the sub-remaining decoding bit(s) is a reverse process of encoding the fine energy based on the sub-remaining encoding bit(s) in the above embodiment. The process can be as follows: extracting the quantization information of the each sub-band in the audio bitstream according to the sub-remaining decoding bit(s), and then decoding the sub-remaining decoding bit(s), the quantization information and the set energy resolution to obtain the fine energy. Specifically, the process of decoding the sub-remaining decoding bit(s), the quantization information and the set energy resolution can be as follows: first, calculating the sub-remaining decoding bit power of 2 to obtain an exponential operation result; then summing the quantization information with 0.5, and multiplying the summation result with the set energy resolution to obtain a multiplication result; then quotienting the multiplication result with the exponential operation result; finally, subtracting a product result of 0.5 and the set energy resolution from the quotient result to obtain the fine energy. Illustratively, assuming that the quantization information is q2, the set energy resolution is Q, and the sub-remaining bit is b, the fine energy can be expressed as F2=rounding ((q2+0.5)*Q/2\hat{ }b−0.5Q).

S330: determining an audio frame based on the coarse energy and the fine energy.

Specifically, the way to determine the audio frame based on the coarse energy and the fine energy can be as follows: determining residual energy according to the coarse energy and the fine energy; determining a spectral shape of each sub-band; and determining the audio frame based on the residual energy and the spectral shape.

The spectral shape is the spectral shape of the each sub-band.

Specifically, the method to determine the high frequency band residual energy of an audio frame according to the coarse energy and the fine energy can be as follows: accumulating the coarse energy and the fine energy to obtain each sub-band residual energy in the high frequency band of the audio frame. Among them, the sub-band residual energy can be understood as the high frequency band logarithmic residual energy. Illustratively, it can be expressed as: F=F1+F2.

Specifically, the method to determine the spectral shape of the each sub-band can be as follows: randomly generating a spectral shape of the each sub-band; or, determining the spectral shape of the each sub-band according to at least one of a spectral shape of a historical audio frame, a spectral shape of a low frequency band, white noise or a spectral shape predicted based on a machine learning model.

The method to determine the spectral shape of an audio frame according to a spectral shape of a historical audio frame can be as follows: superimposing the spectral shape of the historical audio frame on the randomly generated spectral shape to obtain the spectral shape of the audio frame.

Specifically, the way to determine an audio signal of the audio frame based on high frequency band residual energy and the spectral shape can be as follows: obtaining predicted logarithmic energy of the audio frame; accumulating the predicted logarithmic energy and the logarithmic residual energy to obtain the actual logarithmic energy; and determining the audio signal of the audio frame based on the actual logarithmic energy and the spectral shape.

The predicted logarithmic energy can be the predicted logarithmic energy corresponding to each sub-band in the high frequency band, the logarithmic residual energy can be the logarithmic residual energy corresponding to the each sub-band in the high frequency band, and the actual logarithmic energy can be the actual logarithmic energy corresponding to the each sub-band in the high frequency band. The predicted logarithmic energy of the each sub-band can be obtained by linear superposition of the actual logarithmic energy of this sub-band in the previous audio frame and the actual logarithmic energy of the previous sub-band. Illustratively, assuming that the actual logarithmic energy of the previous audio frame in this sub-band is Q1 and the actual logarithmic energy of the previous sub-band in the audio frame is Q2, the predicted logarithmic energy of the sub-band can be expressed as: c*Q1+Q2, where c is an inter-frame prediction coefficient, which can be set in advance. Assuming that the logarithmic residual energy is F, the formula for calculating the actual logarithmic energy can be expressed as: F+c*Q1+Q2.

Optionally, the process of determining the actual logarithmic energy according to the coarse energy and the fine energy can also be as follows: first, accumulating the coarse energy and the predicted logarithmic energy, and then accumulating the accumulation result with the fine energy to obtain the actual logarithmic energy.

The method to determine the audio frame of the audio frame based on the actual logarithmic energy and the spectral shape can be as follows: first, converting the actual logarithmic energy into the actual energy, then determining a spectrum signal corresponding to the each sub-band according to the actual energy and the spectral shape of each sub-band, and finally determining the audio frame of the audio frame based on the spectrum signal corresponding to each sub-band.

Through the audio decoding method provided in the above embodiment, the listening experience of the decoded audio data in the whole frequency band can be improved.

FIG. 4 is a structural schematic diagram of an audio encoding apparatus provided by an embodiment of the present disclosure. As shown in FIG. 4, an audio encoding apparatus 40 includes:
a first encoding module 410, configured for encoding coarse energy of a plurality of sub-bands of a high frequency band corresponding to an audio frame to obtain a first bitstream; and
a second encoding module 420, configured for encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

In some embodiments, the audio coding apparatus 40 further includes a residual energy division module 430, configured for:
dividing residual energy of the each sub-band into the coarse energy and the fine energy based on a set energy resolution, wherein the residual energy of the each sub-band is a difference between actual energy and predicted energy of the each sub-band.

In some embodiments, the coarse energy is a part of the residual energy that is capable of being evenly divided by the set energy resolution, and the fine energy is a remainder part of the residual energy after being evenly divided by the set energy resolution.

In some embodiments, the residual energy division module 430 is further configured to:
for the each sub-band, converting the actual energy of the sub-band to a logarithmic domain to obtain actual logarithmic energy of the sub-band;
determining a difference between the actual logarithmic energy and predicted logarithmic energy of the sub-band to obtain logarithmic residual energy of the sub-band; and
dividing, based on the set energy resolution, the logarithmic residual energy of the sub-band into the coarse energy and the fine energy.

In some embodiments, the remaining encoding bits are a result of subtracting encoding bit(s) for preprocessing the audio frame and encoding bits for encoding the coarse energy of the plurality of sub-bands from the set encoding bits.

In some embodiments, the preprocessing includes encoding of silent frame(s), pre-filtering, encoding of transient frame(s), and encoding of predicted energy.

In some embodiments, the audio encoding apparatus 40 further comprises a remaining encoding bit allocation module 440, which is configured for:
allocating the remaining encoding bits to the plurality of sub-bands according to an allocation ratio of the plurality of sub-bands, wherein bit(s) allocated to the each sub-band are integer multiple of bit(s).

In some embodiments, the remaining encoding bit allocation module 440 is further configured for:
allocating, in response to remaining unallocated encoding bit(s), the unallocated encoding bit(s) to a part of the plurality of sub-bands based on the allocation ratio in an order from low frequency band to high frequency band, wherein bit(s) allocated to each sub-band are integer multiple of bit(s).

In some embodiments, the second encoding module 420 is further configured for:
quantizing the sub-remaining encoding bit(s) of the each sub-band according to the sub-remaining bit(s) and the set energy resolution to obtain quantization information of the sub-remaining encoding bit(s); and
writing the quantization information into the encoded bitstream of the audio frame.

FIG. 5 is a structural schematic diagram of an audio decoding apparatus provided by an embodiment of the present disclosure. As shown in FIG. 5, an audio decoding apparatus 50 includes:
a coarse energy determination module 510, configured for decoding a first bitstream in an audio bitstream to determine coarse energy of a plurality of sub-bands in a high frequency band;
a fine energy acquisition module 520, configured for decoding, based on sub-remaining decoding bit(s) obtained by allocating remaining decoding bit(s) to the plurality of sub-bands, a second bitstream in the audio bitstream to obtain fine energy, wherein the remaining decoding bit(s) are determined according to used decoding bits and set decoding bits, and the used decoding bits are determined according to decoding bit(s) for decoding the first bitstream; and
an audio frame determination module 530, configured for determining an audio frame based on the coarse energy and the fine energy.

In some embodiments, the used decoding bits comprise a sum of decoding bit(s) for preprocessing the audio bitstream and the decoding bit(s) for decoding the first bitstream.

In some embodiments, the preprocessing comprises decoding of silent frame(s), pre-filtering, decoding of transient frame(s), and decoding of predicted energy.

In some embodiments, the sub-remaining decoding bit(s) allocated to the plurality of sub-bands are determined according to an allocation ratio of the remaining decoding bit(s) in the plurality of sub-bands.

In some embodiments, the audio frame determination module 530 is further configured for:
determining residual energy according to the coarse energy and the fine energy;
determining a spectral shape of each sub-band; and
determining the audio frame based on the residual energy and the spectral shape.

In some embodiments, the audio frame determination module 530 is further configured for:
generating the spectral shape of the each sub-band randomly; or,
determining the spectral shape of the each sub-band according to at least one of a spectral shape of a historical audio frame, a spectral shape of a low frequency band, white noise or a spectral shape predicted based on a machine learning model.

The audio encoding apparatus provided by the embodiment of the present disclosure can perform the audio encoding method provided by any embodiment of the present disclosure, and the audio decoding apparatus provided by the embodiment of the present disclosure can perform the audio decoding method provided by any embodiment of the present disclosure, and have corresponding functional modules and beneficial effects for performing the method.

It is worth noting that respective units and modules included in the above apparatus are only divided according to functional logic, but they are not limited to the above division, as long as the corresponding functions can be realized; in addition, the specific names of respective functional units are only for the convenience of distinguishing each other, and are not used to limit the protection scope of the embodiment of the present disclosure.

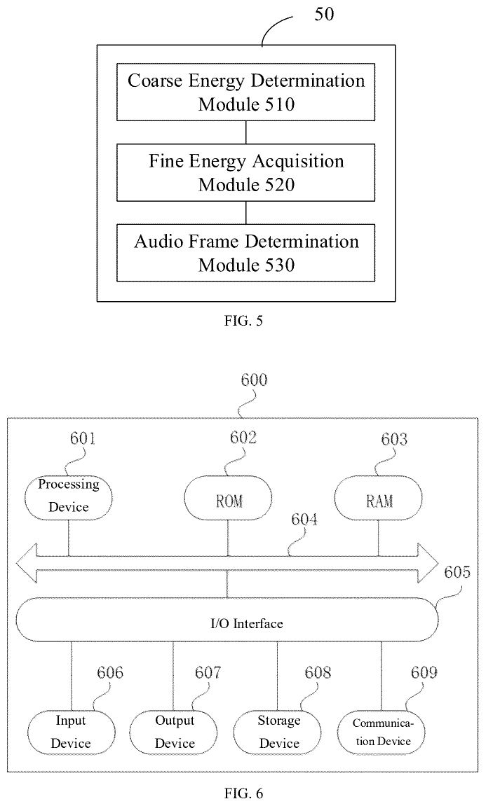

FIG. 6 is a structural schematic diagram of an electronic device provided by an embodiment of the present disclosure. Referring now to FIG. 6, it shows a structural schematic diagram of an electronic device (e.g., terminal device or server in FIG. 6) 600 suitable for implementing the embodiment of the present disclosure. The terminal device in the embodiment of the present disclosure may include, but is not limited to, a mobile terminal such as a mobile phone, a notebook computer, a digital broadcast receiver, a PDA (personal digital assistant), a PAD (tablet), a PMP (portable multimedia player), a vehicle terminal (e.g., a car navigation terminal), and etc., and a fixed terminal such as a digital TV, a desktop computer, and etc. The electronic device shown in FIG. 6 is only an example, and should not bring any limitation to the functions and the scope of the application of the embodiments of the present disclosure.

As shown in FIG. 6, the electronic device 600 may include a processing device (e.g., a central processer, a graphics processor, etc.) 601 that may perform various appropriate actions and processes according to a program stored in a read-only memory (ROM) 602 or a program loaded from a storage device 608 into a random access memory (RAM) 603. In the RAM 603, various programs and data necessary for the operation of the electronic device 600 are also stored. The processing device 601, the ROM 602, and the RAM 603 are connected to each other via a bus 604. An editing/output (I/O) interface 605 is also connected to the bus 604.

Generally, the following devices can be connected to the I/O interface 605: an input device 606 including, for example, a touch screen, touch pad, keyboard, mouse, camera, microphone, accelerometer, gyroscope, etc.; an output device 607 including, for example, a Liquid Crystal Display (LCD), speaker, vibrator, etc.; a storage device 608 including, for example, magnetic tape, hard disk, etc.; and a communication device 609. The communication device 609 may allow the electronic device 600 to communicate with other devices wirelessly or by wire to exchange data. While FIG. 6 illustrates an electronic device 600 having various means, it should be understood that it is not required to implement or provide all of the means shown. More or fewer means may be alternatively implemented or provided.

In particular, the processes described above with reference to the flow diagrams may be implemented as computer software programs, according to the embodiment of the present disclosure. For example, an embodiment of the present disclosure includes a computer program product comprising a computer program carried on a non-transitory computer readable medium, the computer program containing program code for performing the method illustrated by the flow diagram. In such an embodiment, the computer program may be downloaded and installed from the network via the communication device 609, or installed from the storage device 608, or installed from the ROM 602. When executed by the processing device 601, the computer program performs the above-described functions defined in the method of the embodiments of the present disclosure.

The names of messages or information exchanged between devices in the embodiments of the present disclosure are for illustrative purposes only, and are not intended to limit the scope of the messages or information.

The electronic device provided by the embodiment of the present disclosure belongs to the same inventive concept as the audio encoding method or audio decoding method provided by the above embodiment, and the technical details not described in detail in this embodiment can be found in the above embodiment, and this embodiment has the same beneficial effects as the above embodiment.

An embodiment of the present disclosure provides a non-transitory computer storage medium on which a computer program is stored, which, when executed by a processor, implements the audio encoding method or audio decoding method provided by the above embodiment.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in combination with an instruction execution system, apparatus, or device. In contrast, in the present disclosure, a computer readable signal medium may include a data signal propagated in a baseband or as a part of a carrier wave, wherein a computer readable program code is carried therein. Such a propagated data signal may take a variety of forms, including, but not limited to, an electro-magnetic signal, an optical signal, or any suitable combination thereof. A computer-readable signal medium may be any computer readable medium other than a computer-readable storage medium and the computer-readable signal medium can communicate, propagate, or transport a program for use by or in combination with an instruction execution system, apparatus, or device. Program code embodied on a computer-readable medium may be transmitted using any appropriate medium, including but not limited to: electrical wires, optical cables, RF (radio frequency), etc., or any suitable combination thereof.

In some embodiments, the client and the server can communicate using any currently known or future-developed network protocol, such as HTTP (HyperText Transfer Protocol), and may be interconnected to digital data communication (e.g., a communication network) of any form or medium. Examples of communication networks include a local area network (“LAN”), a wide area network (“WAN”), the Internet (e.g., the Internet), and a peer-to-peer network (e.g., ad hoc peer-to-peer network), as well as any known or future developed network.

The computer readable medium may be included in the above-mentioned electronic device; or it may exist alone without being assembled into the electronic device.

The non-transitory computer-readable medium carries one or more programs, which, when executed by the electronic device, cause the electronic device to: encode coarse energy of a plurality of sub-bands of a high frequency band corresponding to an audio frame to obtain a first bitstream; and encode fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

Alternatively, the non-transitory computer-readable medium carries one or more programs, which, when executed by the electronic device, cause the electronic device to: encode coarse energy of a plurality of sub-bands of a high frequency band corresponding to an audio frame to obtain a first bitstream; and encode fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

Computer program code for carrying out operations of the present disclosure may be written in one or more programming languages or a combination thereof, the programming languages include, but are not limited to an object oriented programming language such as Java, Smalltalk, C++, and also include conventional procedural programming languages, such as the “C” programming language, or similar programming languages. The program code can be executed entirely on the user's computer, partly on the user's computer, as an independent software package, partly on the user's computer and partly executed on a remote computer, or entirely on the remote computer or server. In the scenario involving a remote computer, the remote computer may be connected to the user's computer through any type of network, including a Local Area Network (LAN) or a Wide Area Network (WAN), or may be connected to an external computer (for example, through the Internet using an Internet service provider).

The flow diagrams and block diagrams in the figures illustrate the architecture, functionality, and operation that are possibly implemented by systems, methods and computer program products according to various embodiments of the present disclosure. In this regard, each block in the flow diagrams or block diagrams may represent a module, program segment, or portion of code, which comprises one or more executable instructions for implementing the specified logical function(s). It should also be noted that, in some alternative implementations, the functions noted in the blocks may occur in an order different from that noted in the figures. For example, two blocks shown in succession may, in fact, be executed substantially concurrently, or they may sometimes be executed in a reverse order, depending upon the function involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The units described in the embodiments of the present disclosure may be implemented by software or hardware. Wherein the name of a unit does not in some cases constitute a limitation on the unit itself. For example, the first acquisition unit can also be described as “a unit for acquiring at least two Internet protocol addresses”.

The functions described herein above may be performed, at least in part by one or more hardware logic components. For example, without limitation, exemplary types of hardware logic components that may be used include Field Programmable Gate Arrays (FPGAs), Application Specific Integrated Circuits (ASICs), Application Specific Standard Products (ASSPs), Systems on a Chip (SOCs), Complex Programmable Logic Devices (CPLDs), and so forth.

In the context of this disclosure, a machine readable medium may be a tangible medium that can contain, or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples of the machine readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The above descriptions are only preferred embodiments of the present disclosure and are illustrative of the principles of the technology employed. It will be appreciated by those skilled in the art that the scope of disclosure of the present disclosure is not limited to the technical solutions formed by specific combinations of the above-described technical features, and should also encompass other technical solutions formed by any combination of the above-described technical features or equivalents thereof without departing from the concept of the present disclosure. For example, the technical solutions formed by the above features be replaced with (but not limited to) features having similar functions disclosed in the present disclosure.

Further, although operations are depicted in a particular order, this should not be understood as requiring such operations to be performed in the particular order shown or in sequential order. Under certain circumstances, multitasking and parallel processing may be advantageous. Likewise, although several specific implementation details are included in the above discussion, these should not be construed as limitations on the scope of the present disclosure. Certain features that are described in the context of a single embodiment can also be implemented in combination in the single embodiment. Conversely, various features that are described in the context of a single embodiment can also be implemented in multiple embodiments separately or in any suitable subcombination.

Although the present subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. An audio encoding method, comprising:
encoding coarse energy of a plurality of sub-bands of a high frequency band corresponding to an audio frame to obtain a first bitstream; and
encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

2. The audio encoding method according to claim 1, further comprising:
dividing residual energy of the each sub-band into the coarse energy and the fine energy based on a set energy resolution, wherein the residual energy of the each sub-band is a difference between actual energy and predicted energy of the each sub-band.

3. The audio encoding method according to claim 2, wherein the coarse energy is a part of the residual energy that is capable of being evenly divided by the set energy resolution, and the fine energy is a remainder part of the residual energy after being evenly divided by the set energy resolution.

4. The audio encoding method according to claim 2, wherein the dividing residual energy of the each sub-band into the coarse energy and the fine energy based on a set energy resolution comprises:
for the each sub-band, converting the actual energy of the sub-band to a logarithmic domain to obtain actual logarithmic energy of the sub-band;
determining a difference between the actual logarithmic energy and predicted logarithmic energy of the sub-band to obtain logarithmic residual energy of the sub-band; and
dividing, based on the set energy resolution, the logarithmic residual energy of the sub-band into the coarse energy and the fine energy.

5. The audio encoding method according to claim 1, wherein the remaining encoding bits are a result of subtracting encoding bit(s) for preprocessing the audio frame and encoding bits for encoding the coarse energy of the plurality of sub-bands from the set encoding bits.

6. The audio encoding method according to claim 5, wherein the preprocessing comprises encoding of silent frame(s), pre-filtering, encoding of transient frame(s), and encoding of predicted energy.

7. The audio encoding method according to claim 1, further comprising:
allocating the remaining encoding bits to the plurality of sub-bands according to an allocation ratio of the plurality of sub-bands, wherein bit(s) allocated to the each sub-band are integer multiple of bit(s).

8. The audio encoding method according to claim 7, further comprising:
allocating, in response to remaining unallocated encoding bit(s), the unallocated encoding bit(s) to a part of the plurality of sub-bands based on the allocation ratio in an order from low frequency band to high frequency band, wherein bit(s) allocated to each sub-band are integer multiple of bit(s).

9. The audio encoding method according to claim 1, wherein the encoding the fine energy of the plurality of sub-bands based on the sub-remaining encoding bit(s) of the each sub-band of the sub-bands comprises:
quantizing the sub-remaining encoding bit(s) of the each sub-band according to the sub-remaining bit(s) and the set energy resolution to obtain quantization information of the sub-remaining encoding bit(s); and
writing the quantization information into the encoded bitstream of the audio frame.

10. An audio decoding method, comprising:
decoding a first bitstream in an audio bitstream to determine coarse energy of a plurality of sub-bands in a high frequency band;
decoding, based on sub-remaining decoding bit(s) obtained by allocating remaining decoding bit(s) to the plurality of sub-bands, a second bitstream in the audio bitstream to obtain fine energy, wherein the remaining decoding bit(s) are determined according to used decoding bits and set decoding bits, and the used decoding bits are determined according to decoding bit(s) for decoding the first bitstream; and
determining an audio frame based on the coarse energy and the fine energy.

11. The audio decoding method according to claim 10, wherein the used decoding bits comprise a sum of decoding bit(s) for preprocessing the audio bitstream and the decoding bit(s) for decoding the first bitstream.

12. The audio decoding method according to claim 11, wherein the preprocessing comprises decoding of silent frame(s), pre-filtering, decoding of transient frame(s), and decoding of predicted energy.

13. The audio decoding method according to claim 10, wherein the sub-remaining decoding bit(s) allocated to the plurality of sub-bands are determined according to an allocation ratio of the remaining decoding bit(s) in the plurality of sub-bands.

14. The audio decoding method according to claim 10, wherein the determining the audio frame based on the coarse energy and the fine energy comprises:
determining residual energy according to the coarse energy and the fine energy;
determining a spectral shape of each sub-band; and
determining the audio frame based on the residual energy and the spectral shape.

15. The audio decoding method according to claim 14, wherein the determining the spectral shape of the each sub-band comprises:
generating the spectral shape of the each sub-band randomly; or,
determining the spectral shape of the each sub-band according to at least one of a spectral shape of a historical audio frame, a spectral shape of a low frequency band, white noise or a spectral shape predicted based on a machine learning model.

16. An electronic device comprising:
at least one memory; and
at least one processor coupled to the memory, the processor being configured to, based on instructions stored in the memory, perform an audio encoding method comprising:
encoding coarse energy of a plurality of sub-bands of a high frequency band corresponding to an audio frame to obtain a first bitstream; and
encoding fine energy of the plurality of sub-bands based on sub-remaining encoding bit(s) of each sub-band of the sub-bands to obtain a second bitstream, wherein the first bitstream and the second bitstream are for forming an encoded bitstream of the audio frame, and the sub-remaining encoding bit(s) of the each sub-band are determined by allocating remaining encoding bits to the each sub-band, and the remaining encoding bits are determined according to set encoding bits and encoding bits for encoding the coarse energy of the plurality of sub-bands.

17. The electronic device according to claim 16, wherein the processor is configured for:
dividing residual energy of the each sub-band into the coarse energy and the fine energy based on a set energy resolution, wherein the residual energy of the each sub-band is a difference between actual energy and predicted energy of the each sub-band.

18. An electronic device comprising:
at least one memory; and
at least one processor coupled to the memory, the processor being configured to, based on instructions stored in the memory, perform the audio decoding method according to claim 10.

19. A non-transitory computer-readable storage medium on which a computer program is stored, which, when executed by a processor, implements the audio encoding method according to claim 1.

20. A non-transitory computer-readable storage medium on which a computer program is stored, which, when executed by a processor, implements the audio decoding method according to claim 10.
